(19) United States
(12) Patent Application Publication
(10) Pub. No.: US 2023/0380401 A1
(43) Pub. Date: Nov. 30, 2023

(54) Insect Capturing Assembly

(71) Applicant: Oronzo Di Bono, Egg Harbor City, NJ (US)

(72) Inventor: Oronzo Di Bono, Egg Harbor City, NJ (US)

(21) Appl. No.: 17/752,448

(22) Filed: May 24, 2022

(51) Int. Cl. A01M 1/14

(52) U.S. Cl. CPC A01M 1/145

(57) ABSTRACT

An insect capturing assembly includes an ornament that is substantially hollow and a gripping element that is integrated into the ornament. A tube is slidably integrated into the ornament and the gripping element releasably engages the tube. The ornament is positionable in a stored position has the tube contained within the ornament and the ornament is positionable in a deployed position having the tube extending outwardly from the ornament. An adhesive layer is wrapped around the tube to capture flying insects that land on the adhesive layer. A base is coupled to the tube and the base is positionable on a horizontal support surface. A plurality of light emitters is each coupled to the base such that each of the light emitters emits light when the light emitters are turned on.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to insect devices and more particularly pertains to a new insect device for capturing flying insects. The device includes an ornament and a tube that is slidably integrated into the ornament. The tube can be extended out of the ornament or the tube can be contained within the ornament. An adhesive layer is wrapped around the tube for capturing flying insects when the tube is extended out of the ornament. A base is coupled the tube and a plurality of light emitters is coupled to the base for emitting light.

### (2) Description of Related Art Including Information Disclosed Under 37 CFR 1.97 and 1.98

The prior art relates to insect devices including an ornament for a flag pole that can be positioned around the flag pole. The prior art discloses an insect trap that includes a decorative cover, a container and a funnel. The prior art discloses a decorative doll that is positionable on a frustoconical mount. The prior art discloses an insect trap that includes a base structure and a decorative cover for the base structure. The prior art discloses a fly trap that is structured to resemble a potted plant. The prior art discloses a yellow jacket trap that includes a perforated cylinder and a sleeve that is positionable around the perforated cylinder.

### BRIEF SUMMARY OF THE INVENTION

An embodiment of the disclosure meets the needs presented above by generally comprising an ornament that is substantially hollow and a gripping element that is integrated into the ornament. A tube is slidably integrated into the ornament and the gripping element releasably engages the tube. The ornament is positionable in a stored position has the tube contained within the ornament and the ornament is positionable in a deployed position having the tube extending outwardly from the ornament. An adhesive layer is wrapped around the tube to capture flying insects that land on the adhesive layer. A base is coupled to the tube and the base is positionable on a horizontal support surface. A plurality of light emitters is each coupled to the base such that each of the light emitters emits light when the light emitters are turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an insect capturing assembly according to an embodiment of the disclosure.

FIG. 2 is a cross sectional view taken along line 2-2 of FIG. 1 of an embodiment of the disclosure.

FIG. 3 is a front perspective view of an embodiment of the disclosure.

FIG. 4 is a perspective in-use view of an embodiment of the disclosure.

### DETAILED DESCRIPTION OF THE INVENTION

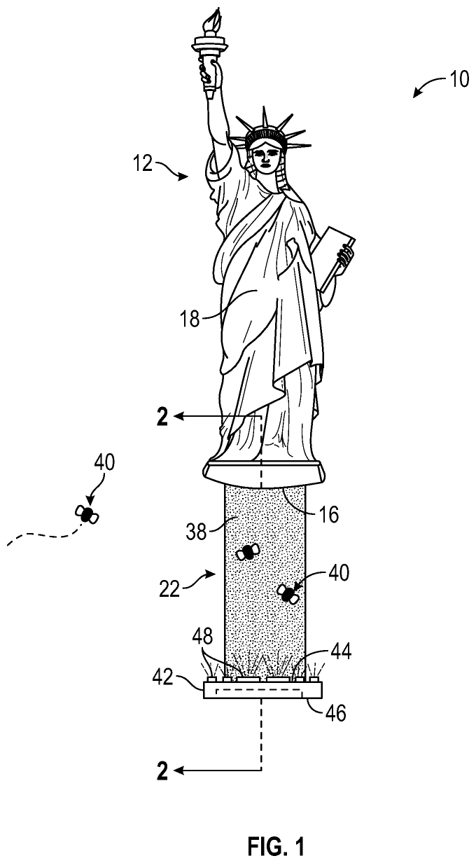

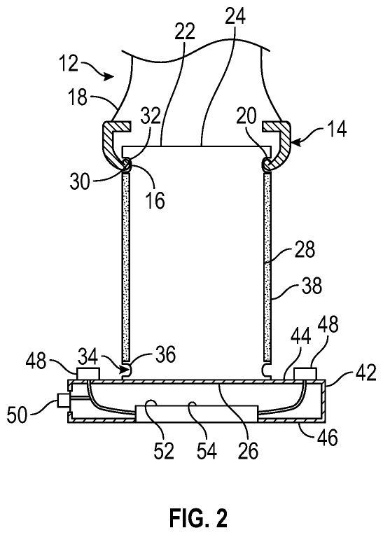

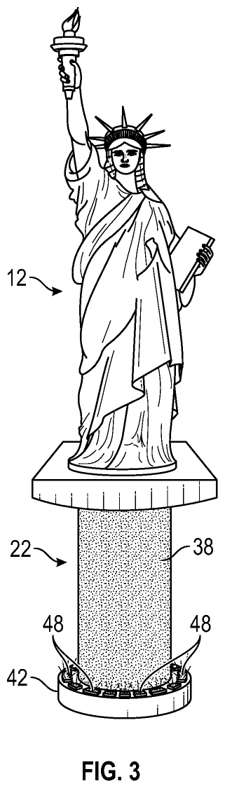

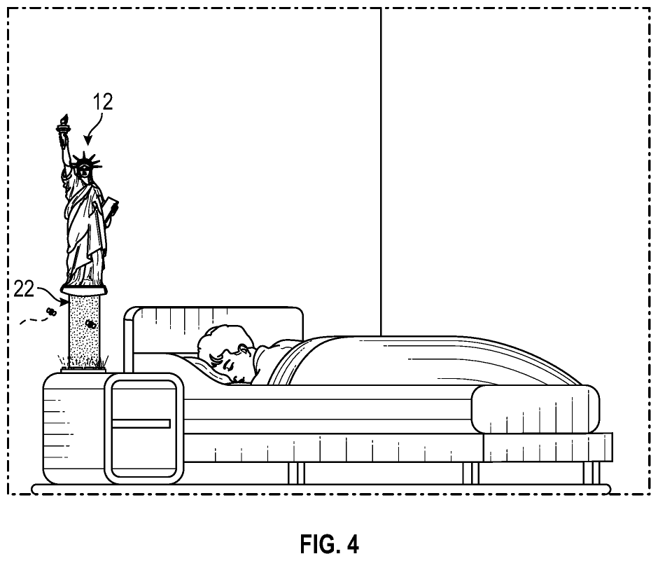

With reference now to the drawings, and in particular to FIGS. 1 through 4 thereof, a new insect device embodying the principles and concepts of an embodiment of the disclosure and generally designated by the reference numeral 10 will be described.

As best illustrated in FIGS. 1 through 4, the insect capturing assembly 10 generally comprises an ornament 12 that is substantially hollow and the ornament 12 has a gripping element 14 that is integrated into the ornament 12. The ornament 12 has a bottom end 16 and an outside wall 18 extending upwardly from the bottom end 16; the bottom end 16 is open into an interior of the ornament 12 defined by the outside wall 18. The bottom end 16 curls inwardly toward a center of the ornament 12, the bottom end 16 is rounded to define a nub 20 extending around a full diameter of the bottom end 16 and the nub 20 defines the gripping element 14. The outside wall 18 of the ornament 12 may be structured to resemble the statue of liberty, for example, or other recognizable monument or structure.

A tube 22 is slidably integrated into the ornament 12 and the gripping element 14 of the ornament 12 releasably engages the tube 22. The ornament 12 is positionable in a stored position having the tube 22 being contained within the ornament 12. The ornament 12 is positionable in a deployed position having the tube 22 extending outwardly from the ornament 12. The tube 22 has an upper end 24, a lower end 26 and an outer surface 28 extending between the upper end 24 and the lower end 26. A first groove 30 is integrated into the outer surface 28 and the first groove 30 extends around a full circumference of the tube 22 and the first groove 30 is positioned adjacent to the upper end 24. The first groove 30 has a bounding surface 32 that is concavely arcuate with respect to the outer surface 28 thereby facilitating the nub 20 on the bottom end 16 of the tube 22 to slide into and out of the first groove 30.

A second groove 34 is integrated into the outer surface 28, the second groove 34 extends around a full circumference of the tube 22 and the second groove 34 is positioned adjacent to the lower end 26. The second groove 34 has a bounding surface 36 that is concavely arcuate with respect to the outer surface 28 thereby facilitating the nub 20 on the bottom end 16 of the tube 22 to slide into and out of the second groove 34. The nub 20 engages the first groove 30 when the tube 22 is positioned in the deployed position and the nub 20 engages the second groove 34 when the tube 22 is positioned in the stored position.

An adhesive layer 38 is wrapped around the tube 22 and the adhesive layer 38 is comprised of an adhesive material thereby facilitating the adhesive layer 38 to capture flying insects 40 that land on the adhesive layer 38. The adhesive layer 38 extends around a full circumference of the outer surface 28 of the tube 22 and the adhesive layer 38 extends between the first groove 30 and the second groove 34. Furthermore, the adhesive layer 38 may be infused with a chemical attractant for attracting the flying insects 40 to land on the adhesive layer 38. A base 42 is coupled to the tube 22 and the base 42 is positionable on a horizontal support surface thereby facilitating the tube 22 to be vertically oriented. In this way the tube 22 is positioned to facilitate the flying insects 40 to land on the tube 22. The base 42 has a top surface 44 and a bottom surface 46, and the lower end 26 of the tube 22 is coupled to the top surface 44 of the base 42 and the tube 22 is centrally positioned on the base 42. The base 42 has a diameter that is greater than a diameter of the tube 22 and the outer surface 28 of the ornament 12 has a diameter is approximately equivalent to the diameter of the base 42.

A plurality of light emitters 48 is provided and each of the light emitters 48 is coupled to the base 42 such that each of the light emitters 48 emits light when the light emitters 48 are turned on. Each of the light emitters 48 is positioned on the top surface 44 of the base 42 and the light emitters 48 are spaced apart from each other and are distributed around the tube 22. A power control 50 is movably coupled to the base 42, the power control 50 is electrically coupled to the plurality of light emitters 48 and the power control 50 turns the light emitters 48 on and off. A power supply 52 is positioned in the base 42, the power supply 52 is electrically coupled to the power control 50 and the power supply 52 comprises at least one battery 54.

In use, the ornament 12 is positioned in the deployed position thereby exposing the adhesive layer 38 on the tube 22. In this way flying insects 40 can be captured on the adhesive layer 38 when the flying insects 40 land on the adhesive layer 38. Additionally, the power control 50 can be manipulated to turn on the light emitters 48 for illuminating the area in which the ornament 12 is positioned. The ornament 12 is positioned in the stored position to conceal the tube 22 within the ornament 12 such that the flying insects 40 on the adhesive layer 38 are not visible to an observer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect capturing assembly for emitting light and capturing insects, said assembly comprising:
an ornament being substantially hollow, said ornament having a gripping element being integrated into said ornament;
a tube being slidably integrated into said ornament, said gripping element of said ornament releasably engaging said tube, said ornament being positionable in a stored position having said tube being contained within said ornament, said ornament being positionable in a deployed position having said tube extending outwardly from said ornament;
an adhesive layer being wrapped around said tube, said adhesive layer being comprised of an adhesive material thereby facilitating said adhesive layer to capture flying insects that land on said adhesive layer;
a base being coupled to said tube, said base being positionable on a horizontal support surface thereby facilitating said tube to be vertically oriented wherein said tube is configured to be positioned to facilitate the flying insects to land on said tube; and
a plurality of light emitters, each of said light emitters being coupled to said base such that each of said light emitters emits light when said light emitters are turned on.

2. The assembly according to claim 1, wherein said ornament has a bottom end and an outside wall extending upwardly from said bottom end, said bottom end being open into an interior of said ornament defined by said outside wall, said bottom end curling inwardly toward a center of said ornament, said bottom end being rounded to define a nub extending around a full diameter of said bottom end, said nub defining said gripping element.

3. The assembly according to claim 2, wherein:
said tube has an upper end, a lower end and an outer surface extending between said upper end and said lower end;
said tube has a first groove being integrated into said outer surface, said first groove extending around a full circumference of said tube, said first groove being positioned adjacent to said upper end, said first groove having a bounding surface being concavely arcuate with respect to said outer surface thereby facilitating said nub on said bottom end of said tube to slide into and out of said first groove;
said tube has a second groove being integrated into said outer surface, said second groove extending around a full circumference of said tube, said second groove being positioned adjacent to said lower end, said second groove having a bounding surface being concavely arcuate with respect to said outer surface thereby facilitating said nub on said bottom end of said tube to slide into and out of said second groove;
said nub engages said first groove when said tube is positioned in said deployed position; and
said nub engages said second groove when said tube is positioned in said stored position.

4. The assembly according to claim 3, wherein said adhesive layer extends around a full circumference of said outer surface of said tube, said adhesive layer extending between said first groove and said second groove.

5. The assembly according to claim 3, wherein:
said base has a top surface and a bottom surface, said lower end of said tube being coupled to said top surface of said base, said tube being centrally positioned on said base, said base having a diameter being greater than a diameter of said tube, said outer surface of said ornament having a diameter being approximately equivalent to said diameter of said base; and
each of said light emitters is positioned on said top surface of said base, said light emitters being spaced apart from each other and being distributed around said tube.

6. The assembly according to claim 1, further comprising:
a power control being movably coupled to said base, said power control being electrically coupled to said plurality of light emitters, said power control turning said light emitters on and off; and
a power supply being positioned in said base, said power supply being electrically coupled to said power control, said power supply comprising at least one battery.

7. An insect capturing assembly for emitting light and capturing insects, said assembly comprising:
an ornament being substantially hollow, said ornament having a gripping element being integrated into said ornament, said ornament having a bottom end and an outside wall extending upwardly from said bottom end, said bottom end being open into an interior of said ornament defined by said outside wall, said bottom end curling inwardly toward a center of said ornament, said bottom end being rounded to define a nub extending around a full diameter of said bottom end, said nub defining said gripping element;
a tube being slidably integrated into said ornament, said gripping element of said ornament releasably engaging said tube, said ornament being positionable in a stored position having said tube being contained within said ornament, said ornament being positionable in a deployed position having said tube extending outwardly from said ornament, said tube having an upper end, a lower end and an outer surface extending between said upper end and said lower end, said tube having a first groove being integrated into said outer surface, said first groove extending around a full circumference of said tube, said first groove being positioned adjacent to said upper end, said first groove having a bounding surface being concavely arcuate with respect to said outer surface thereby facilitating said nub on said bottom end of said tube to slide into and out of said first groove, said tube having a second groove being integrated into said outer surface, said second groove extending around a full circumference of said tube, said second groove being positioned adjacent to said lower end, said second groove having a bounding surface being concavely arcuate with respect to said outer surface thereby facilitating said nub on said bottom end of said tube to slide into and out of said second groove, said nub engaging said first groove when said tube is positioned in said deployed position, said nub engaging said second groove when said tube is positioned in said stored position;
an adhesive layer being wrapped around said tube, said adhesive layer being comprised of an adhesive material thereby facilitating said adhesive layer to capture flying insects that land on said adhesive layer, said adhesive layer extending around a full circumference of said outer surface of said tube, said adhesive layer extending between said first groove and said second groove;
a base being coupled to said tube, said base being positionable on a horizontal support surface thereby facilitating said tube to be vertically oriented wherein said tube is configured to be positioned to facilitate the flying insects to land on said tube, said base having a top surface and a bottom surface, said lower end of said tube being coupled to said top surface of said base, said tube being centrally positioned on said base, said base having a diameter being greater than a diameter of said tube, said outer surface of said ornament having a diameter being approximately equivalent to said diameter of said base;
a plurality of light emitters, each of said light emitters being coupled to said base such that each of said light emitters emits light when said light emitters are turned on, each of said light emitters being positioned on said top surface of said base, said light emitters being spaced apart from each other and being distributed around said tube;
a power control being movably coupled to said base, said power control being electrically coupled to said plurality of light emitters, said power control turning said light emitters on and off; and
a power supply being positioned in said base, said power supply being electrically coupled to said power control, said power supply comprising at least one battery.
